(19) United States
(12) Patent Application Publication
(10) Pub. No.: US 2005/0188969 A1
(43) Pub. Date: Sep. 1, 2005

(54) Throttle body extension device

(76) Inventor: Floyd James Wheeler III, Indio, CA (US)

Correspondence Address: Brian F. Drazich;COUDERT BROTHERS LLP, 23rd Floor, 333 South Hope Street, Los Angeles, CA, 90071, US

(21) Appl. No.: 11/065,472

(22) Filed: Feb. 24, 2005

Related U.S. Application Data
(60) Provisional application No. 60/548,361, filed on Feb. 27, 2004.

(51) Int. Cl. F02M 29/00

(52) U.S. Cl. 123/590

(57) ABSTRACT

A throttle body extension device of a simple design and easy manufacture, having no vanes or circuitous channels, adapted to be installed upstream of the intake manifold in the air-fuel intake system of any internal combustion engine to improve engine operating efficiency and performance. It is emphasized that this abstract is provided to comply with the rules requiring an abstract that will allow a searcher or other reader to quickly ascertain the subject matter of the technical disclosure. It is submitted with the understanding that it will not be used to interpret or limit the scope of the claims.

### CROSS REFERENCE TO RELATED APPLICATIONS

This application claims the benefit of U.S. Provisional Application Ser. No. 60/548,361 filed Feb. 27, 2004, which is incorporated herein by reference.

### FIELD OF THE INVENTION

The present invention is directed to a throttle body extension device adapted to be installed upstream of the intake manifold in the air-fuel intake system of any internal combustion engine to improve engine efficiency and performance.

### DESCRIPTION OF THE PRIOR ART

Various types of throttle body spacers intended to lower fuel usage and emissions, and to increase horsepower and torque are known. For example, U.S. Pat. No. 2,639,230 (the '230 patent) to Lefebre describes a fuel and air mixer block, for use in conjunction with a carburetor, having a straight circular bore or aperture through which the fuel-air mixture flows into the intake manifold. The wall of circular bore of the '230 patent includes a series of longitudinally spaced upwardly inclined circumferential annular flanges, forming an acute angle in cross section, extending opposite to the direction of the fuel-air mixture flow. The '230 patent also includes a cone shaped baffle having similar annular flanges disposed coaxially in the circular bore. U.S. Pat. No. 4,215,663 (the '663 patent) to Gaylord discloses an air fuel inlet device within a throttle body spacer. U.S. Pat. No. 4,086,899 (the '899 patent) to Gaylord discloses throttle body spacer block having a straight circular bore or aperture wherein the wall surface of the bore contains a series of parallel grooves essentially square in cross section disposed perpendicular to the axis of the bore.

U.S. Pat. No. 5,924,398 (the '398 patent) to Choi discloses an air diffuser for an air intake system of an internal combustion engine. The air diffuser of the '398 patent is mounted between the throttle body and intake manifold and includes a plurality of vanes extending into the bore or aperture of the diffuser to reduce noise and sludging within the air intake system. The vanes of the '398 patent may extend either in a parallel direction or radially away from the wall of the bore. However, in the case of radial vanes, the '398 patent discloses that the vanes disposed around the bottom one-half of the circumference of the bore extend approximately one-third the radius of the bore while the vanes disposed around the top one-half of the circumference of the bore are substantially shorter in length.

U.S. Pat. No. 6,073,609 (the '609 patent) to Buswell discloses a throttle body spacer having one or more bores or apertures where the wall of each such bore includes channels extending the full length of the wall that may be formed into a variety of cross-sectional configurations, including U-shaped, V-shaped, rectangular or square, and where each such channel is inclined at an angle to the axis of the bore—in the manner of rifling.

U.S. Pat. No. 6,338,335 (the '335 patent) to Patterson discloses a throttle body spacer having an aperture with shallowly pitched helical grooves—in the manner of pipe threads—where the grooves have a V-shaped cross-section with a flat bottom parallel with the planar upper and lower external surfaces of the spacer.

U.S. Pat. No. 6,367,772 (the '772 patent) to Glogovcsan discloses a throttle body having an air passageway or bore containing a butterfly valve with one or more straight or shallowly pitched helical—in the manner of rifling—grooves or channels optionally disposed generally longitudinally in the bore on one or both sides of the butterfly valve. The grooves or channels have a semi-circular cross-section with a flat bottom parallel with the planar upper and lower external surfaces of the body.

The present invention differs substantially in both scope and function from the prior art designs in that it has no helical or annular channels and no vanes. The present invention may be installed upstream of the intake manifold in the air-fuel intake system of any internal combustion engine, whether carbureted or fuel injected, for the purpose of improving engine operating efficiency (fuel consumption and emissions) and performance (output horsepower and torque).

### SUMMARY OF THE INVENTION

With the objectives of improving conventional throttle body spacers relative to engine efficiency and performance, reducing the cost of manufacture of throttle body extension devices, and providing novel functionality for the present throttle body extension device in comparison to conventional throttle body spacers, the present invention includes features for increasing air charge velocity and turbulence.

It is an object of the present invention to enhance the efficiency of fuel utilization of an internal combustion engine.

It is a further object of the present invention to reduce internal combustion engine emissions by more complete utilization of fuel.

It is yet a further object of the present invention to increase the output power of an internal combustion engine by more complete utilization of fuel.

It is a further object of the present invention to increase the torque output by an internal combustion engine by more complete utilization of fuel.

It is an additional object of the present invention to provide a throttle body extension device that is simple in design to permit easy and efficient manufacture.

It is yet an additional object of the present invention to provide a throttle body extension device that is of durable and reliable maintenance-free construction.

### BRIEF DESCRIPTION OF THE DRAWINGS

FIG. 1 is a top perspective view of a first embodiment of the present invention throttle body extension device unit having a single aperture.

FIG. 2 is a top view of the FIG. 1 embodiment.

FIG. 3 is a bottom perspective view of the FIG. 1 embodiment.

FIG. 4 is a side view of the FIG. 1 embodiment.

FIG. 5 is an end view of the FIG. 1 embodiment.

FIG. 6 is a further top perspective view of a first embodiment of the present invention throttle body extension device unit having a single aperture.

### DESCRIPTION OF EMBODIMENTS OF THE INVENTION

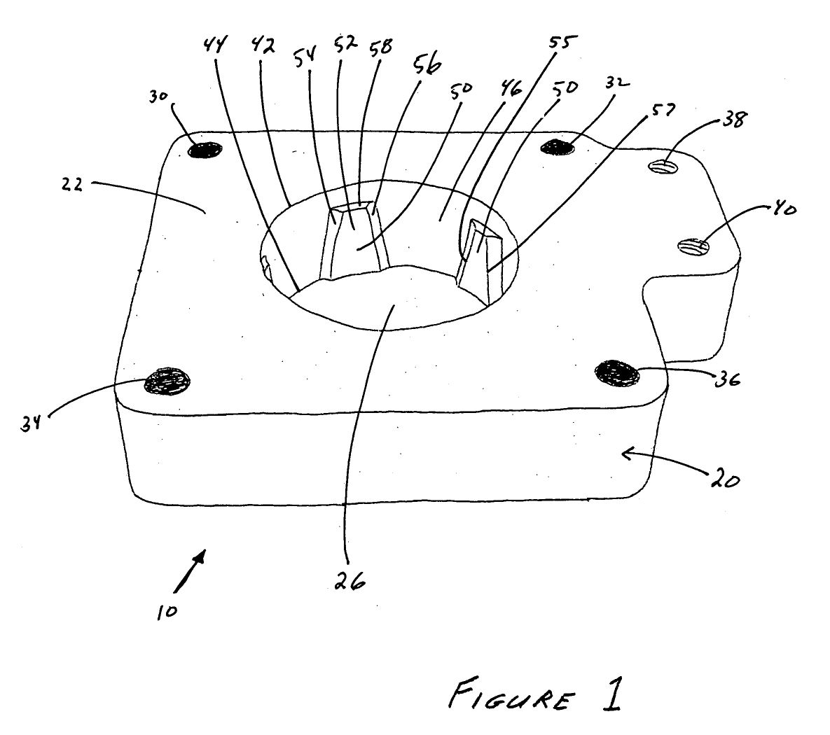

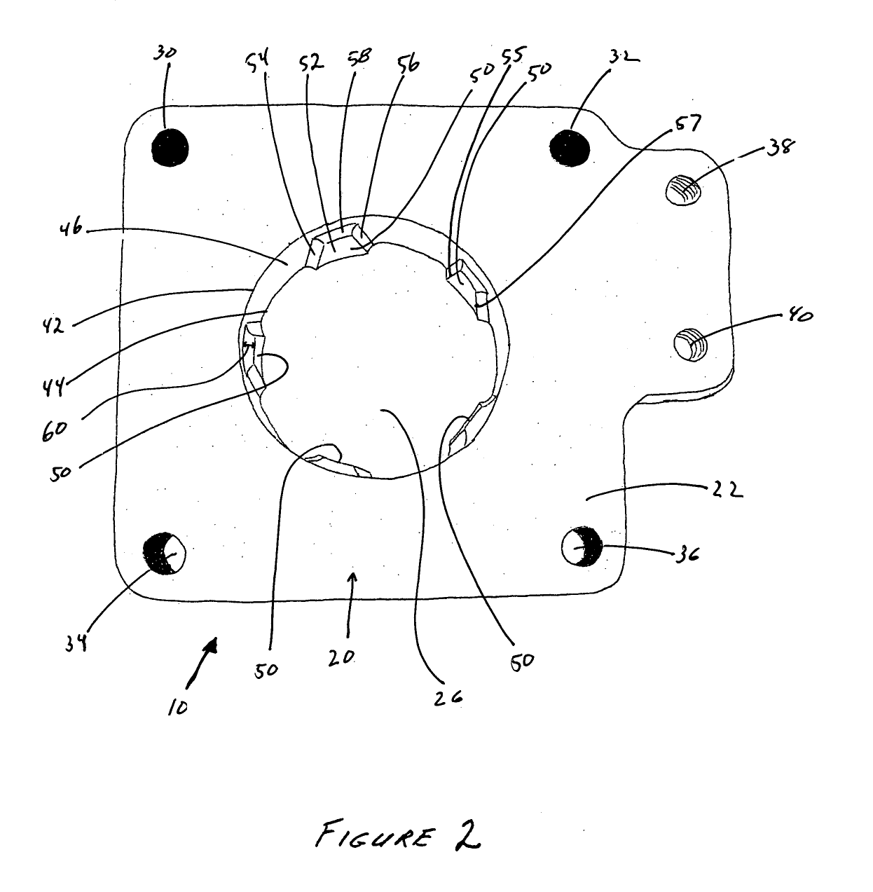

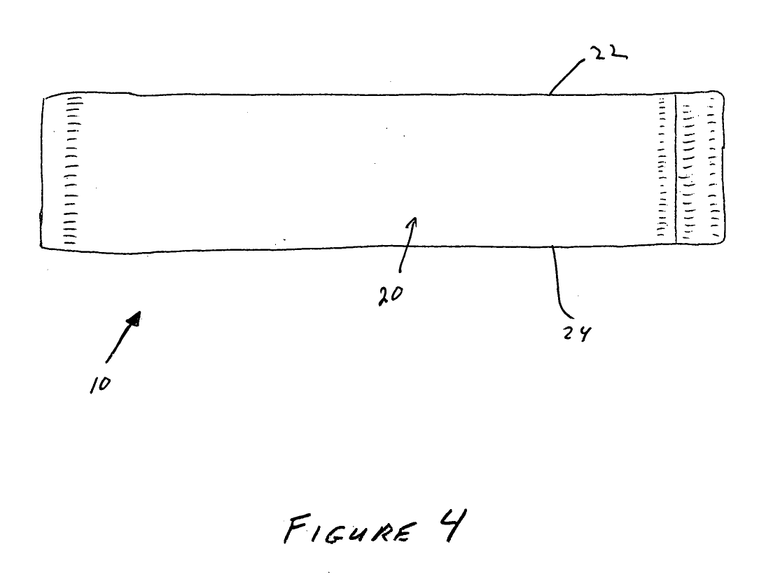

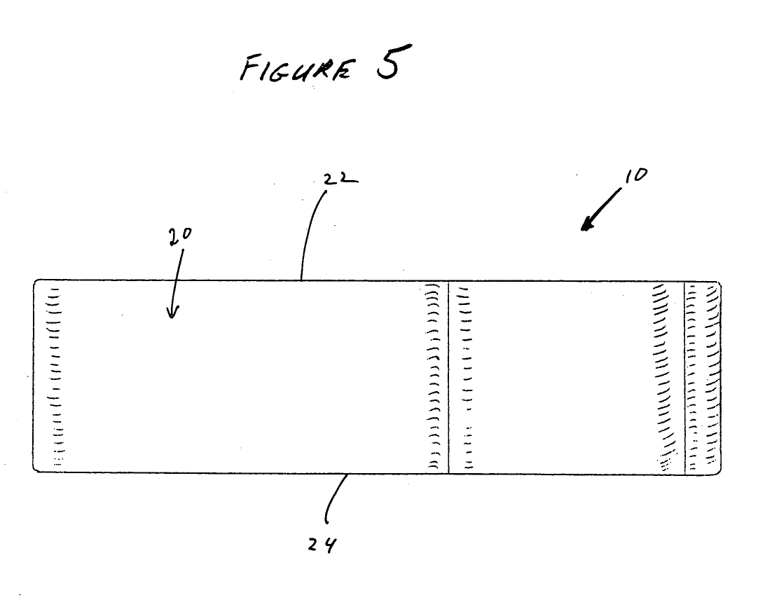

In general, the present invention is directed to improved throttle body extension devices for use in internal combustion engines. Referring to FIGS. 1-5, a first embodiment of the present invention will be described. The embodiment of FIGS. 1-5 is directed to a throttle body extension device that may be and preferably is made from. a single unitary piece of flat stock, such as billet Aluminum, stainless steel or metal-ceramic composites. In the alternative, the present throttle body extension device may be made from component parts that are assembled into a finished or completed throttle body extension device. As is well known, a conventional, throttle body spacer is manufactured from a single piece of material, such as metal and as described in the '335 patent. The throttle body extender unit of FIGS. 1-5 includes novel features that provide additional functionality and that are significant improvements over the throttle body spacers described in the '335 patent and elsewhere in the prior art. It is believed that the additional functionality of the present invention is achieved by increasing air-fuel mixture charge velocity and/or turbulence resulting in more complete utilization of the available chemical energy of the air-fuel mixture upon combustion. With reference to FIGS. 1-5, like numbers describe like parts.

Referring to FIGS. 1-5, the throttle body extension unit, or for convenience, spacer, 10 is formed of a substantially flat and elongated block 20. Block 20 is constructed of relatively rigid material, preferably of a metal such as billet or cast aluminum. Also, other materials may be used such as, for example, stainless steel, metal-ceramic composites, or high temperature polymers all of which are presently known in this field.

With further reference to FIGS. 1-5, the block 20 includes a substantially planar front face 22 and an opposite parallel substantially planar back face 24. The distance between front face 22 and back face 24 defines the height of block 20. The distance between front face 22 and back face 24 may vary from about one-half inch to about two inches or more, as dictated by the particular application. The block 20 also includes at least one aperture 26 that penetrates entirely through block 20 from planar front face 22 to planar back face 24. Aperture 26 is defined by circular front edge 42 at front face 22 and circular back edge 44 at back face 24. Preferably circular edges 42, 44 have equal diameters and are in overlying alignment. In other words, aperture 26 defines a right circular cylindrical opening through block 20 forming aperture wall 46 extending between front edge 42 and back edge 44. In the common case of an aperture 26 having a diameter of from about two inches to about two and one-half inches, the preferred distance or height between front face 22 and back face 24 is about one inch. Thus, the ratio of the aperture diameter to aperture height is from about 1:1 to about 5:1, with a ratio of from about 2:1 to about 2.5:1 being preferred.

Block 20 includes a plurality of holes 30, 32, 34 and 36 for the insertion of bolts, studs or other fastener for attaching the throttle body extension device 10 within the air-fuel intake system of any internal combustion engine. Additionally, block 20 includes holes 38, 40 to facilitate mounting of the spacer 10 or attachment of accessories.

With reference now to FIGS. 1-3, integrally formed with aperture wall 46 and extending outwardly from the. surface of wall 46 is a plurality of protrusions of predetermined shape, size and thickness, having a modified trapezoidal polyhedron appearing configuration, for convenience referred to hereafter as, aperture wedges 50, each having a substantially trapezoidally shaped wedge face 52. Each wedge face 52 may be planar. However, preferably, each aperture wedge 50 is of a modified trapezoidal polyhedral shape such that wedge face 52 preferably is a curvilinear surface having a common axis of curvature with wall 46 and curvilinearly parallel thereto. Each aperture wedge 50 extends along aperture wall 46 in the height dimension of the aperture 26 as measured from back face 24 to front face 22. Each aperture wedge 50 may extend from about 50% to 100% of the height of aperture 26. It has been found that a wedge 50 extending along about 75% of the height of aperture 26, or 75% of the distance between back face 24 and front face 22, is preferred.

With further reference to FIGS. 1-3, wedge 50 is further defined by fillet surfaces 54, 56 that extend along each side edge of wedge face 52 between wedge face 52 and aperture wall 46. Each wedge fillet surface 54, 56 may be planar and along its juncture with wall 46, each forms an angle equal to or greater than about 90° but less than 180° with the exposed surface of wall 46. Alternatively and preferably, each wedge fillet surface 54, 56 is a curvilinear surface (a two dimensional surface essentially flat in a given direction and curved in a non-parallel direction) that preferably joins substantially smoothly with aperture wall 46. Each wedge fillet surface 54, 56 forms an angle equal to or greater than about 90° but less than 180° (measured in the shortest arc) with wedge face 52 and define wedge side edges 55, 57, respectively, at the juncture of wedge fillet surfaces 54, 56, respectively, with wedge face 52. Alternatively, each wedge fillet surface 54, 56 is a curved surface (a two dimensional surface essentially curved, or does not occupy the same plane, in all direction) that preferably joins substantially smoothly with aperture wall 46. From the foregoing it is clear that wedge side edges 55, 57, may define straight or curved lines, but preferably define straight lines.

Wedge top facet 58 may be curvilinear, but is preferably planar. Wedge top facet 58 forms an angle equal to or greater than about 90° but less than 180° (measured in the shortest arc) at its juncture with wedge face 52, and at its juncture with the exposed surface of wall 46 or with the imaginary continued or projected surface of wall 46 outside of block 20 in the case where wedge top facet 58 extends to front edge 42 at front face 22. The perimeter of wedge top facet 58 is defined by the line of its juncture with wedge face 52, fillet surface 54, the surface of aperture wall 46 and fillet surface 56. It will be understood that the juncture of wedge top facet 58 with wedge face 52 will define a straight line in the case where wedge face 52 is planar and will define a curved line in the case where wedge face 52 is curvilinear and parallel with wall 46.

Wedge base facet 59 may be curvilinear, but is preferably planar. Wedge base facet 59 forms an angle equal to or greater than about 90° but less than 180° (measured in the shortest arc) with wedge face 52 at its juncture with wedge face 52. Wedge base facet 59 forms an angle equal to or greater than about 90° but less than 180° (measured in the shortest arc) with the exposed surface of wall 46, or with the imaginary continued or projected surface of wall 46 outside of block 20 in the case where wedge base facet 59 extends to back edge 44 at back face 24. The perimeter of wedge base facet 59 is defined by the line of its juncture with wedge face 52, fillet surface 54, the surface of aperture wall 46 and fillet surface 56. It will be understood that the juncture of wedge base facet 59 with wedge face 52 will define a straight line in the case where wedge face 52 is planar and will define a curved line in the case where wedge face 52 is curvilinear and parallel with wall 46. It will be understood as well, that as described herein, the perimeters of top facet 58 and base facet 59 will include one curved line segment and three straight line segments, or two curved line segments and two straight line segments, or four curved line segments—depending upon whether wedge face 52 and fillet surfaces 54, 56 are planar or curvilinear.

The thickness 60 of each aperture wedge 50 is the radial distance between the imaginary projected surface of aperture wall 46 underlying the aperture wedges 50 and the curvilinearly parallel wedge face 52. In the alternative case of a planar wedge face 52, the thickness 60 of wedge 50 is defined by the radial distance between the imaginary continued or projected surface of aperture wall 46 underlying a wedge 50 and the plane of wedge face 52 along its longitudinal centerline where the centerline is measured along the distance between front face 22 and back face 24, or in other words, along the height dimension of aperture 26.

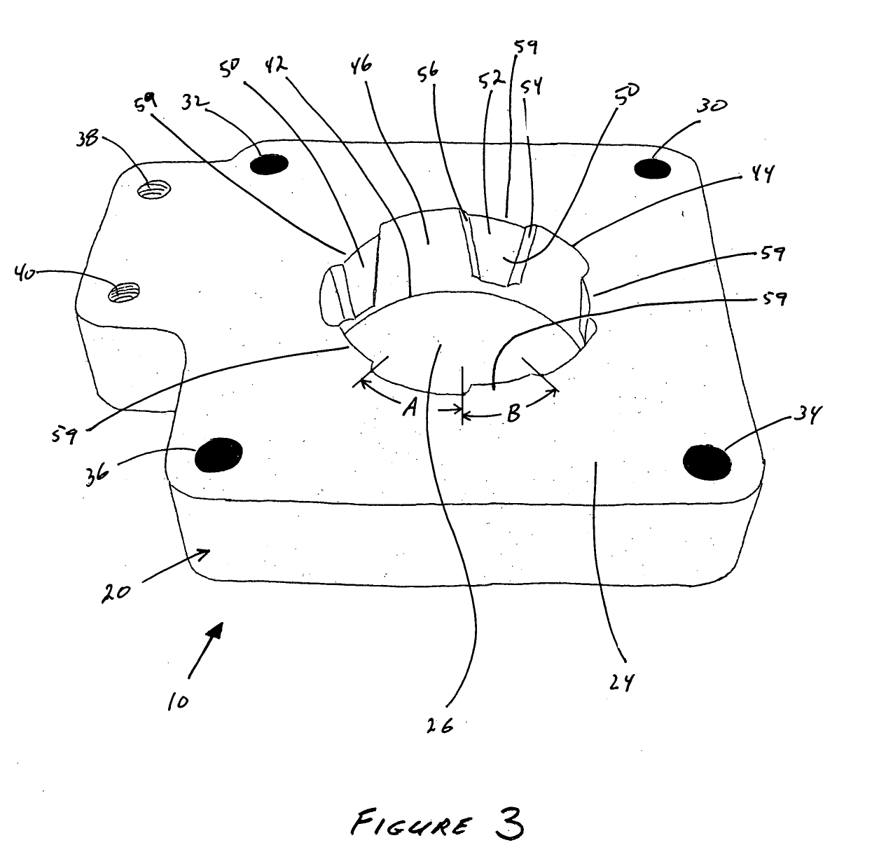

With continued reference to FIGS. 1-3, a plurality of wedges 50 are disposed equidistant around the perimeter of aperture 26 as defined by wall 46. For an aperture 26 having a mean diameter from about two inches to about two and one-half inches, it is preferred that five (5) aperture wedges 50 be uniformly disposed 72 degrees apart around the perimeter of aperture 26, as shown. As shown in FIG. 3, and applicable to all embodiments of the present invention, the base facet 59 of an aperture wedge 50 at its juncture with wall 46 includes or covers an arc of about “B” degrees, while the space or gap between wedges, at the base of the wedges, includes or covers an arc of about “A” degrees. In the first embodiment shown in FIGS. 1-5, arc “A” plus arc “B” equals 72 degrees, and arc “A” is selected to have a predetermined value between about 30 degrees and about 45 degrees. In the first embodiment, it is preferred that the arc “B” at the base 59 of aperture wedge 50 cover an arc of about 36 degrees, while the space or gap arc “A” between the bases of the wedges cover a similar arc of about 36 degrees. While the first embodiment of FIGS. 1-5 is shown as having five (5) aperture wedges 50 uniformly spaced apart by an arc of 72 degrees, it is within the scope of the present invention that the aperture 26 of throttle body extension device 10 could have a plurality of aperture wedges fewer or greater in number than five disposed at equal arc segment intervals around wall 46. For example, where eight (8) aperture wedges 50 are used, the wedges 50 would be spaced apart by an arc of 45 degrees, and arc “A” plus arc “B” would equal 45 degrees. In an instance where eight wedges were used, arc “A” would be selected to have a predetermined value between about 18 degrees and about 27 degrees. In other words, arc “A” equals 40% to 60% of the value in degrees of arc “A” plus arc “B”.

Further, with continued reference to FIGS. 1-3, wedge face 52 is tapered from wider near its junction with wedge base facet 59 to narrower near its junction with wedge top facet 58. Wedge fillet surfaces 54, 56 are disposed to form an acute angle (measured in the shortest arc) of between less than about 90° and more than about 68° relative to a plane co-planar to substantially planar back face 24 that intersects any fillet surface 54 or 56. It has been found that a taper angle of about 80 degrees along each side of wedge face 52 is preferred. In other words, the preferred angle for fillet surfaces 54, 56 is about 80 degrees measured as described above, or about 10 degrees from a normal orthogonal to the plane of substantially planar back face 24. The thickness 60 of a wedge 50 has a predetermined value preferably from about 5% to about 25% of the radius of aperture 26. For an aperture 26 having a radius from about one inch to about one and one-quarter inches, it has been determined that a wedge thickness 60 of about 1/8 inch, or from about 10% to about 13% of the aperture radius, is preferred.

While the embodiment of FIGS. 1-5 is shown sized for and having a single aperture 26, it is within the scope of the present invention that the throttle body extension device could be sized for and have a plurality of apertures 26 to accommodate a variety of intake manifold, carburetor or fuel injection system designs. Additionally, although the embodiment of the present invention shown in FIGS. 1-5 depicts an aperture 26 approximately two and one-quarter inches in diameter, it is within the scope of the present invention that the aperture 26 could have a diameter smaller or larger than about two and one-quarter inches as may be required by the particular air-fuel intake system in which the throttle body extension device 10 is to be installed.

It is within the scope of the present invention that the aperture 26 may include a plurality of aperture wedges 50 fewer or greater in number than five, and that the wedges 50 may each be sized, within the parameters discussed above, as may be required by a particular application. For example, and by way of explanation and illustration only, it may be that a particular hypothetical application could require a throttle body extension device 10 with an aperture 26 diameter of three inches and having seven aperture wedges 50. Such a throttle body extension device is within the scope of the present invention.

Further, although the embodiment of the present invention shown in FIGS. 1-5 depicts the aperture wedges 50 disposed with wedge base surfaces 59 occupying the same plane as back face 24, it is within the scope of the present invention that aperture wedges 50 may be disposed along aperture wall 46 between front face 22 and back face 24, with the wedge base surfaces 59 formed between front face 22 and back face 24, and not occupying the same plane as back face 24. Additionally, although the embodiment of the present invention described herein and shown in FIGS. 1-5 depicts the aperture wedges 50 as having a uniform thickness 60, it is within the scope of the present invention that the thickness 60 of a wedge 50 may vary from about 0% to about 25% of the radius of aperture 26 at points between top facet 58 and base facet 59 and/or at points between side edge 55 and side edge 57. Finally, although the embodiment of the present invention shown in FIGS. 1-5 depicts wedge top facet 58 and wedge base facet 59 as single surfaces, top facet 58 and base facet 59 each may contain more than one such surface element. Such a throttle body extension device is within the scope of the present invention.

While the present invention has been described in connection with what is presently considered to be the most practical and preferred embodiments, it is to be understood that the invention is not to be limited to the disclosed embodiments, but to the contrary, is intended to cover various modifications and equivalent arrangements included within the spirit of the invention, which are set forth in the appended claims, and which scope is to be accorded the broadest interpretation so as to encompass all such modifications and equivalent structures.

1. A throttle body extension device comprising:
a block having a substantially planar front face and an opposite substantially parallel substantially planar back face adapted for mounting to an intake manifold of an internal combustion engine;
a cylindrical aperture defining an aperture wall penetrating said block between said front face and said back face;
a plurality of raised wedges each having a predetermined thickness formed on said aperture wall;
said plurality of wedges spaced uniformly apart circumferentially about said aperture wall;
each said raised wedge bounded by a top facet and a base facet;
each said raised wedge top facet extending a predetermined circumferential arc length along said aperture wall;
each said raised wedge base facet extending a predetermined circumferential arc length along said aperture wall greater than the arc length of its corresponding top facet;
the top facet of each raised wedge disposed a predetermined distance from said front face;
the base facet of each raised wedge disposed a predetermined distance from said back face; and
the distance from the top facet of each raised wedge to said front face than is less than the distance from the corresponding base facet of each raised wedge to said front face.

2. A throttle body extension device comprising:
a block adapted for mounting to an intake manifold of an internal combustion engine;
said block having a substantially planar front face and a substantially parallel substantially planar back face;
the distance between the front face of the block and the back face of the block defining a predetermined block height;
a circular cylindrical aperture of predetermined diameter defining an aperture wall extending through the block between the front face and the back face;
the predetermined diameter of said aperture and said predetermined block height having a ratio from about 1:1 to about 5:1;
a plurality of protrusions of predetermined shape, size and thickness integrally formed on the aperture wall;
said plurality of protrusions wider near said back face and narrower near said front face equally spaced apart around the circumference of said aperture.

3. A throttle body extension device comprising:
a block adapted for mounting to an intake manifold of an internal combustion engine having a substantially planar front face and an opposite substantially parallel substantially planar back face;
a circular cylindrical aperture having a predetermined radius defining an aperture wall extending through the block between the front face and the back face adapted to provide fluid communication with said intake manifold;
a plurality of protrusions integrally formed on the aperture wall each extending about 50% to 100% of the distance between said front face and said back face;
said plurality of protrusions having a uniform thickness of about 5% to about 25% of said radius;
each of said plurality of protrusions having a trapezoidally shaped face defining two non-parallel edges of substantially equal length and two substantially parallel edges of unequal length;
each of said two non-parallel edges forming an acute angle of about 80° with said substantially planar back face; and
said plurality of protrusions equally spaced apart around the circumference of said aperture.
